(19) United States
(12) Patent Application Publication
(10) Pub. No.: US 2011/0308243 A1
(43) Pub. Date: Dec. 22, 2011

(54) FLUID CIRCULATION SYSTEM

(76) Inventor: Kapena Whitford, Kihei, HI (US)

(21) Appl. No.: 13/163,604

(22) Filed: Jun. 17, 2011

Related U.S. Application Data
(60) Provisional application No. 61/356,512, filed on Jun. 18, 2010.

(51) Int. Cl. F03B 11/00; F03B 1/00; F04B 43/08

(52) U.S. Cl. 60/398; 417/476

(57) ABSTRACT

Systems for circulation a fluid through a system and substituent component systems of the same. In one example, a pressure input system includes a bladder support, an expelling element, and a roll-up bladder configured to spool about the expelling element. The bladder support can rotate about an axis of rotation between at least a first configuration and a second configuration. The bladder support can include a first end and a second end opposite the first end. A distance between the first end and a ground surface when the bladder support is in the first configuration can be greater than a distance between the second end and the ground surface and a distance between the first end and the ground surface when the bladder support is in the second configuration can be less than a distance between the second end and the ground surface.

### CROSS-REFERENCE TO RELATED APPLICATIONS

This application claims the benefit of U.S. Provisional Application No. 61/356,512 filed on Jun. 18, 2010, titled “FLUID CIRCULATION SYSTEM,” which is hereby expressly incorporated by reference in its entirety.

### BACKGROUND

1. Field

Embodiments disclosed herein relate generally to systems for circulating a fluid. More specifically, certain embodiments concern fluid circulations systems that include a gravity driven pump system used to pressurize a working fluid, for example, water.

2. Description of the Related Art

Fluid circulation systems can be used to circulate a working fluid through one or more energy conversion elements, for example, a turbine or paddle wheel. Embodiments disclosed herein relate to pressure input systems, for example, gravity driven pump systems, that can be incorporated in a fluid circulation system to provide a pressurized working fluid to an energy conversion system.

### SUMMARY

The systems, devices, and methods disclosed herein each have several aspects, no single one of which is solely responsible for their desirable attributes. Without limiting the scope of the claims, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description of Certain Embodiments,” one will understand how the features of the devices and methods disclosed herein provide advantages over other known devices and methods.

In one embodiment a system for circulating fluid may include, for example, a fluid storage reservoir, a pressure input system, and an energy conversion system. The fluid storage reservoir can be disposed above a ground surface and configured to store at least a portion of a working fluid. The pressure input system can be disposed between the fluid storage reservoir and the ground surface. The pressure input system can also be configured to receive the working fluid from the fluid storage reservoir and pressurize the received working fluid. The energy conversion system can be configured to receive pressurized working fluid from the pressure input system and direct the pressurized working fluid over at least one energy conversion element.

In certain aspects, the at least one energy conversion element can include a water wheel and an electrical generator can be operatively coupled to the water wheel. The water wheel can include, for example, at least one paddle configured to engage the pressurized working fluid. The at least one energy conversion element can also include a pelton wheel that can be operatively coupled to an electrical generator. The pressure input system can be a gravity driven pump system and the system for circulating fluid can also include a pressure input re-set system.

In another embodiment, a pressure input system may include, for example, a bladder support, an expelling element, and a bladder. The bladder support can be configured to rotate about an axis of rotation between at least a first configuration and a second configuration. The bladder support can include a first end and a second end opposite the first end with a distance between the first end and a ground surface when the bladder support is in the first configuration being greater than a distance between the second end and the ground surface. Similarly, a distance between the first end and the ground surface when the bladder support is in the second configuration can be less than a distance between the second end and the ground surface. The expelling element can be configured to travel, for example, on a surface of the bladder support between a first position and a second position. The first position can be disposed nearer to the first end than the second end and the second position can be disposed nearer to the second end than the first end. The bladder can be disposed over the bladder support and coupled to the expelling element. The bladder can be configured to spool around the expelling element when the expelling element travels from the second position to the first position. The bladder can be configured to un-spool from the expelling element when the expelling element travels from the first position to the second position. The bladder can include an aperture configured to receive and expel a working fluid therethrough.

In certain aspects, the expelling element can be configured to expel working fluid from the bladder as the expelling element travels from the second position to the first position. The pressure input system can further include, for example, a first releasable latch configured to releasably secure the expelling element relative to the bladder support when the expelling element is in the first position. The pressure input system can further include a second releasable latch configured to releasably secure the expelling element relative to the bladder support when the expelling element is in the second position. The pressure input system can further include an input lumen positioned to fluidly communicate with the bladder aperture when the bladder support is in the first position and a first lumen latch mechanism coupled to the input lumen. The first lumen latch mechanism can be configured to engage the bladder aperture when the bladder support is in the first position and/or can be configured to releasably secure the bladder to the input lumen when the bladder support is in the first position. The first lumen latch mechanism can include a one-way valve configured to allow the working fluid to pass therethrough from the input lumen into the bladder. The pressure input system can also include an output lumen positioned to fluidly communicate with the bladder aperture when the bladder support is in the second position. The pressure input system can further include a second lumen latch mechanism coupled to the output lumen with the second lumen latch mechanism being configured to engage the bladder aperture when the bladder support is in the second position. The second lumen latch mechanism can be configured to releasably secure the bladder to the output lumen when the bladder support is in the second position. The second lumen latch mechanism can include a one-way valve that is configured to allow the working fluid to pass therethrough from the bladder into the output lumen.

In one embodiment, an expelling element can include, for example, a first wheel, a second wheel spaced apart from the first wheel, and an axle extending between the first wheel and the second wheel. The first wheel and the second wheel can form a receiving space therebetween configured to receive at least a portion of a bladder, for example, a roll-up bladder. At least a portion of the axle can be configured to couple to the bladder to spool and un-spool the bladder thereabout.

In another embodiment, a pressure input re-set system can include, for example, a hydro-prop configured to rotate about an axle. The hydro-prop can include a first blade and a second blade with the first blade including a first blade lumen and a first blade lumen aperture exposed to the atmosphere and the second blade include a second blade lumen and a second blade lumen aperture exposed to the atmosphere. The pressure input re-set system can also include an input lumen configured to receive a pressurized working fluid therethrough and a diverter. The diverter can be fluidly coupled to the input lumen, the first blade lumen, and the second blade lumen. The diverter can be configured to establish a first fluid pathway between the input lumen and the first blade lumen and a second fluid pathway between the input lumen and the second blade lumen. The pressure input re-set system can be coupled to a system for circulating fluid and/or a pressure input system. In some aspects, the pressure input re-set system can be coupled to a source of energy, for example, waste energy, unused energy, or excess energy, and the source of energy can be utilized to at least partially drive the pressure input re-set system to re-set one or more pressure input systems.

In certain aspects, the first blade lumen can have a diameter characteristic that is less than a diameter characteristic of the input lumen. The second blade lumen can have a diameter characteristic that is less than a diameter characteristic of the input lumen. The first blade lumen aperture can face a direction of rotation about the axle that is opposite to a direction of rotation about the axle that the second blade lumen aperture faces.

In yet another embodiment, a method of manufacturing a system for circulating fluid includes disposing a fluid storage reservoir above a ground surface, fluidly coupling the fluid storage reservoir to a pressure input system such that the pressure input system is configured to receive a working fluid from the fluid storage reservoir, and fluidly coupling an energy conversion system to the pressure input system such that the energy conversion system is configured to receive pressurized working fluid from the pressure input system.

In another embodiment, a method of circulating fluid can include, for example, providing a source of working fluid to a gravity driven pump system, pressurizing the working fluid in the gravity driven pump system, and providing at least a portion of the pressurized working fluid to an energy conversion system. In one aspect, the method can also include providing a portion of the pressurized working fluid to a pump re-set system.

In yet another embodiment, a method of manufacturing a pressure input system can include, for example, providing a bladder support having a first end and a second end opposite the first end, rotatably coupling the bladder support to a stand such that the bladder support can move between at least a first configuration and a second configuration, disposing a bladder expelling element on the bladder support such that the bladder expelling element can move between at least a first position and a second position on the bladder support, and coupling a bladder to the bladder expelling element such that the bladder is configured to spool about the bladder expelling element as the bladder expelling element moves from the first position to the second position.

In one embodiment, a method of pressurizing a working fluid can include, for example, providing a working fluid into a bladder such that the bladder un-spools over a bladder support, rotating the bladder support about an axis of rotation such that a bladder expelling element is biased toward an opposite end of the bladder support, and releasing the bladder expelling element such that the bladder expelling element travels toward the opposite end of the bladder support and expels a working fluid from the bladder.

In yet another embodiment, a method of manufacturing a pressure input re-set system can include, for example, providing a hydro-prop including at least a first blade, the first blade including a first blade lumen and a first blade lumen aperture exposed to the atmosphere, rotatably coupling the hydro-prop to an axle such that the hydro-prop is rotatable about the axle, and fluidly coupling an input lumen to the first blade lumen. In certain aspects, the method can further include coupling the hydro-prop to a winch system.

In another embodiment, a method of re-setting a pressure input system can include, for example, providing a source of pressurized working fluid to a pressure input re-set system, the pressure input re-set system including at least one hydro-prop configured to rotate around an axis of rotation upon receipt by the pressure input re-set system of the pressurized working fluid, and converting the rotational motion of the hydro-prop to linear motion to re-set a pressure input system that is operatively coupled to the pressure input re-set system. In some aspects, a method of re-setting one or more pressure input systems can include, for example, providing a source of energy (e.g., waste energy, unused energy, or excess energy) to at least one pressure input re-set system (e.g., at least one hydro-prop) to at least partially drive the at least one pressure input re-set system to re-set the one or more pressure input systems.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a block diagram schematically illustrating one embodiment of a fluid circulation system.

FIG. 2 is a perspective view schematically illustrating an embodiment of an energy conversion system.

FIGS. 3A-3D are side elevational views schematically illustrating an embodiment of a pressure input system.

FIG. 4 is a perspective view schematically illustrating an embodiment of a roll-up bladder expelling element.

FIG. 5 is a perspective view schematically illustrating an embodiment of a pump re-set system.

FIG. 6A is a side elevational view of a rotatable arm that may be incorporated in one embodiment of a pressure input re-set system.

FIG. 6A′ is a front elevational view of the rotatable arm of FIG. 6A.

FIG. 6B is a side elevational view of a rotatable frame that may be incorporated in one embodiment of a pressure input re-set system.

FIGS. 7A-7E are side elevational views schematically illustrating a pressure input re-set system incorporating the rotatable arm of FIGS. 6A and 6A′ and the rotatable frame of FIG. 6B.

FIGS. 8A and 8B are side elevational views of the pressure input re-set system of FIGS. 7A-7E disposed with the pressure input system of FIGS. 3A-3D.

### DETAILED DESCRIPTION OF CERTAIN EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Fluid circulation systems can be used to cycle working fluids through one or more energy conversion systems. Fluid circulation systems can be incorporated in different types of power plants, including, for example, hydro-electric plants, nuclear power plants, solar concentrator plants, fossil fuel based plants, and geothermal plants. In one example, fluid circulation systems can be used to cycle a pressurized liquid, for example, pressurized water, through a water wheel, a hydro-prop, a turbine, and/or any other suitable energy conversion element, to generate energy. Embodiments disclosed herein generally relate to fluid circulation systems, and substituent components of fluid circulation systems, configured to cycle a working fluid through at least one energy conversion system to create electrical energy. Some embodiments disclosed herein incorporate pressure input systems, for example, gravity driven pump systems to at least partially pressurize a working fluid that can be cycled through an energy conversion system in a fluid circulation system. Additionally, various embodiments disclosed herein relate to pressure input re-set systems configured to re-set, for example, a gravity driven pressure input system such that additional portions of a working fluid can be pressurized and electrical energy can be generated from the pressurized working fluid. In some embodiments, pressure input re-set systems can be driven, at least in part, by pressurized working fluid received from a pressure input system or from another source of energy as discussed below.

Some embodiments of fluid circulation systems disclosed herein, and/or the substituent components of such systems, can be configured to utilize, convert, or harness energy that may otherwise be wasted, unused, or used less efficiently. For example, some embodiments of fluid circulation systems and/or fluid circulation system components can be operatively coupled with one or more sources of waste energy, for example, steam, pressurized fluid, and/or heat. Suitable sources of waste energy can include, for example, machines, systems, devices, conduits, vehicles, structures, and/or buildings (e.g., industrial buildings). In some embodiments, one or more sources of waste energy are coupled to a fluid circulation system to promote the circulation of a working fluid therethrough. For example, a source of waste energy can be operatively coupled to a pressure input re-set system to at least partially drive the re-set system to re-set a corresponding pressure input system. In this way, the embodiments used herein can be implemented to circulate a fluid through one or more energy conversion systems and/or may be used to efficiently utilize sources of energy that would otherwise be wasted, unused, or used differently.

Several non-limiting examples of embodiments will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments can include several novel features, no single one of which is solely responsible for its desirable attributes or which is essential to practicing the technology herein described.

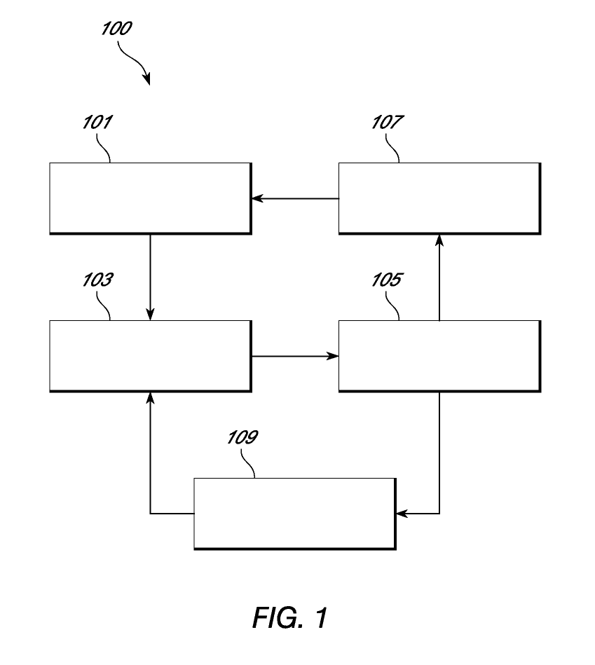

FIG. 1 is a block diagram schematically illustrating one embodiment of a fluid circulation system 100. The fluid circulation system 100 includes a low pressure fluid storage reservoir 101 that is fluidly coupled to a pressure input system 103 and an energy conversion system 107. The low pressure fluid storage reservoir 101 can be formed of various structures including, for example, pipes, tanks, and/or troughs. In one embodiment, the low pressure fluid storage reservoir 101 can be positioned higher than the pressure input system 103 such that a working fluid cycled through the system 100 can travel from the lower pressure fluid storage reservoir to the pressure input system 103 by gravity. In some embodiments, the fluid storage reservoir 101 can include an open or closed trough that is positioned between 6 feet and 8 feet above the pressure input system 103 such that water is driven by gravitational forces to flow from the low pressure fluid storage reservoir 101 to the pressure input system 103.

The pressure input system 103 can include any structure or system configured to pressurize a working fluid, for example water. In some embodiments, the pressure input system 103 can include, for example, a pump configured to pressurize the working fluid to a pressure of about 80 pounds per square inch or higher. In one embodiment, the pressure input system 103 can include, for example, a gravity driven pump system including a roll-up bladder and a bladder expelling element configured to expel a working fluid from the roll-up bladder. As discussed in further detail below, in embodiments where the pressure input system 103 is gravity driven, the pressure input system 100 may be periodically re-set (e.g., lowered and/or raised) such that a working fluid may be driven by gravity into the pressure input system 100 to be pressurized. In such embodiments, the fluid circulation system 100 may further include a pressure input re-set system 109.

In one embodiment, the pressure input re-set system 109 can be driven, at least partially, by pressurized working fluid that is provided by an elevated pressure fluid storage reservoir 105 that receives and stores fluid from the pressure input system 103. In one embodiment, the pressure input re-set system 109 can be driven, at least partially, by pressurized working fluid that is provided directly from the pressure input system 103. In some embodiments, the pressure input re-set system 109 can be configured to utilize, convert, or harness energy that may otherwise be wasted, unused, or used less efficiently. In this way, the pressure input re-set system 109 can be at least partially driven with energy that is not produced by the fluid circulation system 100. For example, in some embodiments the pressure input re-set system 109 can be operatively coupled with one or more sources of waste energy, for example, steam, pressurized fluid, and/or heat. In some examples, the source of energy may be suitable for use by the pressure input re-set system 109 and may be directly coupled thereto by ducts, channels, conduits, wires, cables, or other direct coupling mechanisms. In other examples, the source of energy may be converted by one or more systems to a more suitable form using various energy transfer systems such as turbines, heat transfer devices, or other energy transfer devices or systems and the converted or energy may be utilized by the pressure input re-set system 109.

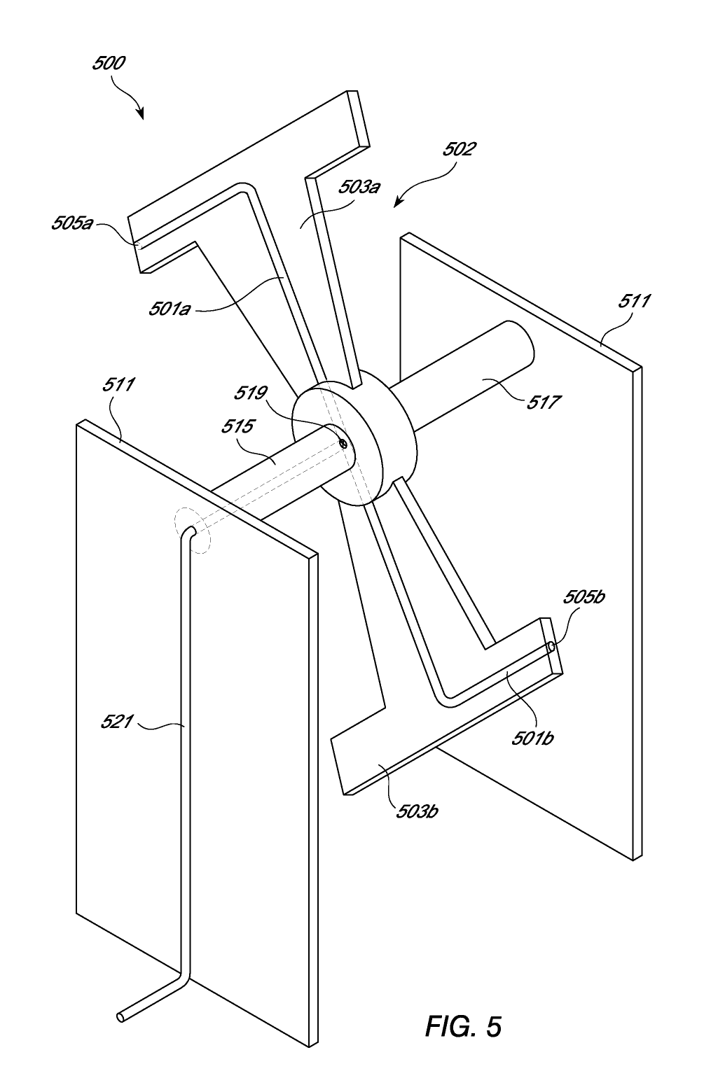

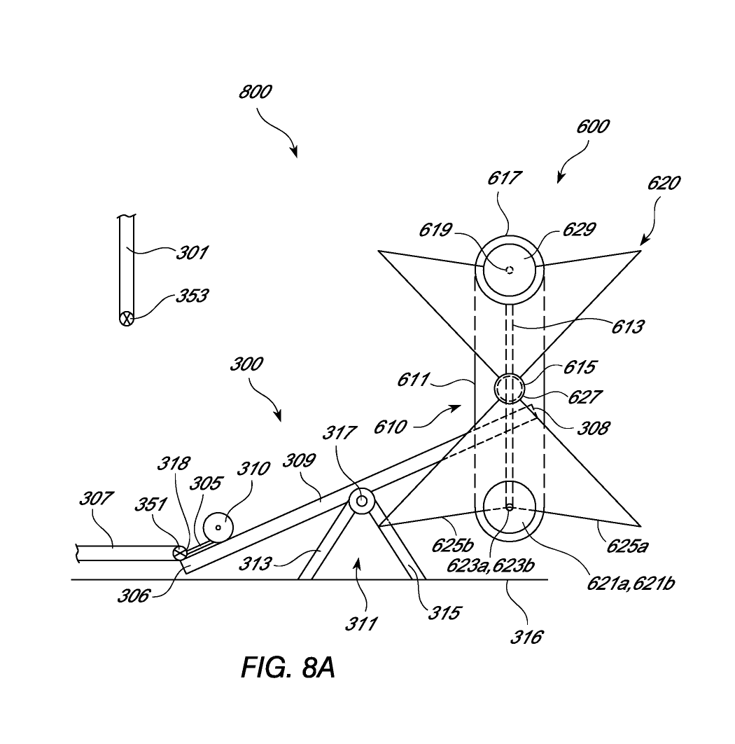

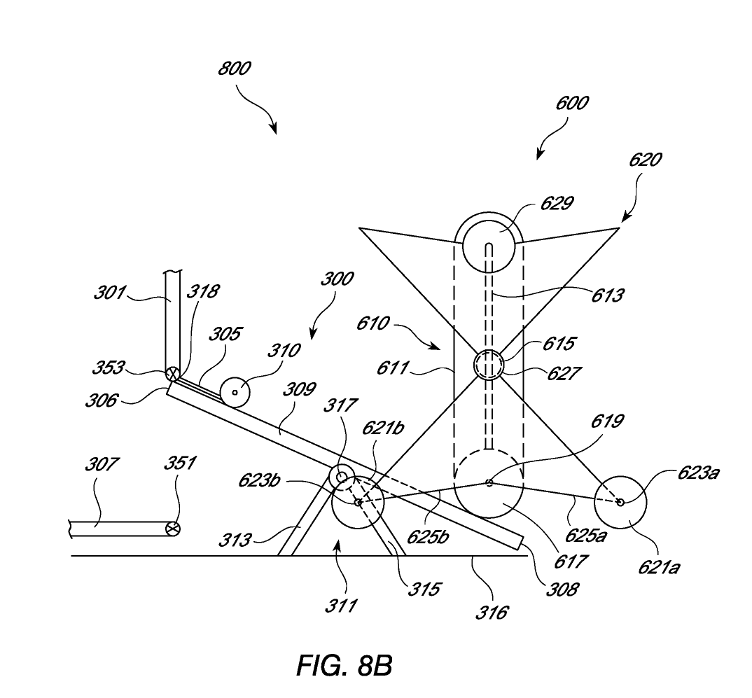

The elevated pressure fluid storage reservoir 105 can be formed of various structures, for example, tanks with one-way valves and/or septums to maintain a certain elevated pressure threshold within the elevated pressure fluid storage reservoir 105. In one embodiment, the elevated pressure fluid storage reservoir 105 can include a first one-way valve that receives working fluid therethrough from the pressure input system 103, a second one-way valve that receives working fluid passing from the elevated pressure fluid storage reservoir to the pressure input re-set system 109, and a third one-way valve that receives working fluid passing from the elevated pressure storage reservoir to the energy conversion system 107. In some embodiments, the pressure input re-set system 109 can include, for example, a hydraulic system, a float system (e.g., a buoy system), a counter weight system (e.g., FIGS. 8A and 8B), and/or a hydro-prop system (FIG. 5). The pressure input re-set system 109 can optionally be coupled to a pulley system (not shown) to create a mechanical advantage to re-set (e.g., raise or lower) the pressure input system 103.

The elevated pressure fluid storage reservoir 105 can be fluidly coupled to the energy conversion system 107 such that pressurized working fluid can be released from the elevated pressure fluid storage reservoir 105, for example, through a one-way valve, and cycled through the energy conversion system 107. In some embodiments, the energy conversion system 107 can include one or more energy conversion elements configured to generate energy when the working fluid is cycled therethrough. In some embodiments, the energy conversion elements can be, for example, water wheels or pelton wheels configured to turn an axle when pressurized fluid passes over the paddles of the wheels. The water wheels or pelton wheels can be coupled to one or more electrical generators such that rotation of the wheels effected by the working fluid causes the electrical generators to generate electrical energy. In this way, energy stored within the pressurized working fluid can be converted to energy for use by one or more components that are not part of the fluid circulation system 100. In some embodiments, electrical energy produced by the energy conversion system 107 can be stored, for example, by one or more batteries and/or delivered directly to an energy consuming element and/or to a power grid. Working fluid that has passed over the energy storage elements and energy conversion system 107 can be directed to the low pressure fluid storage reservoir 101 and cycled through the fluid circulation system 100 repeatedly.

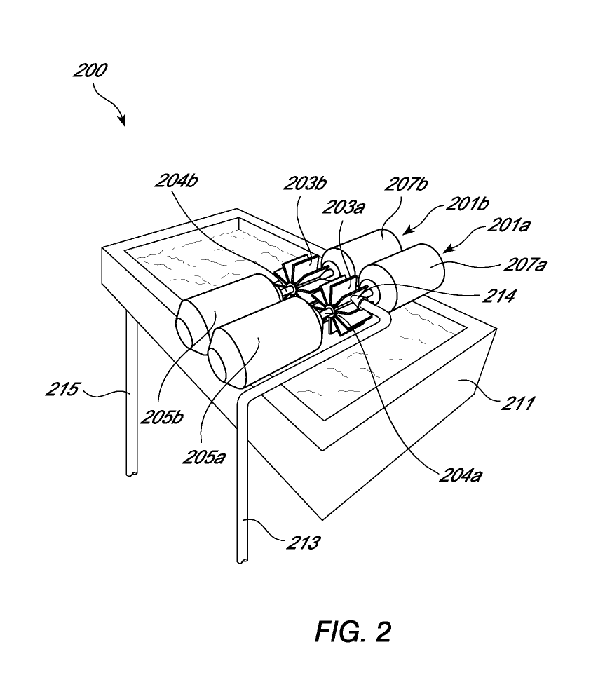

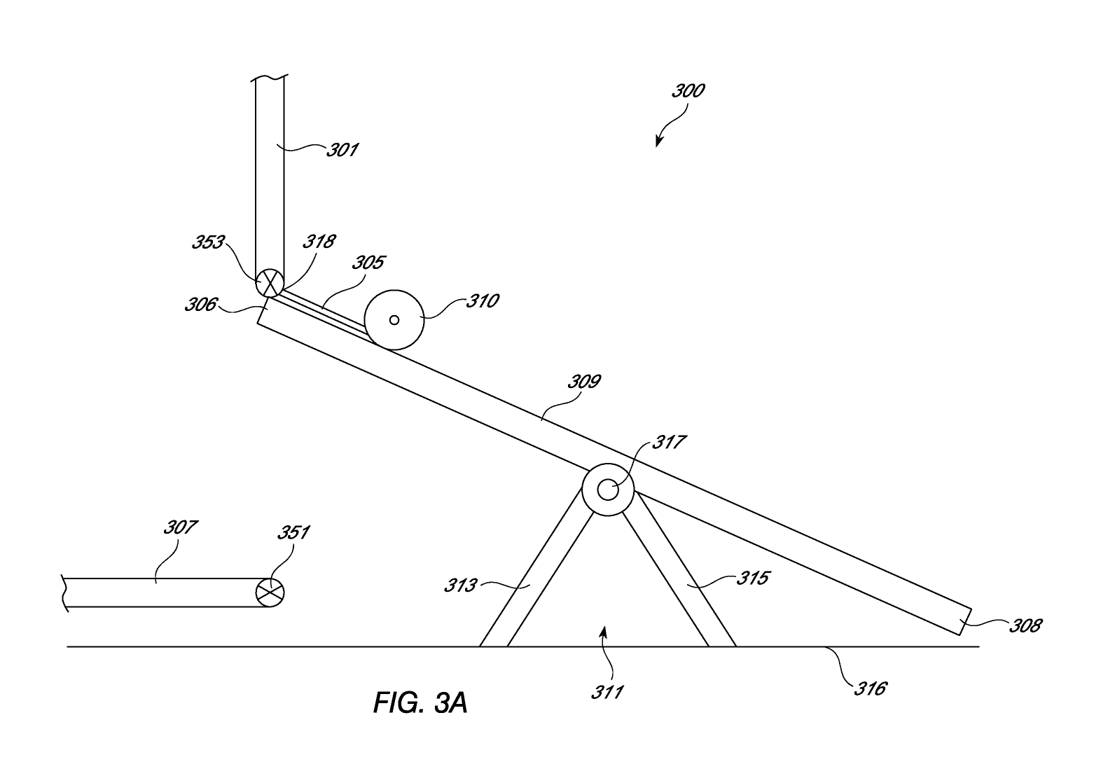

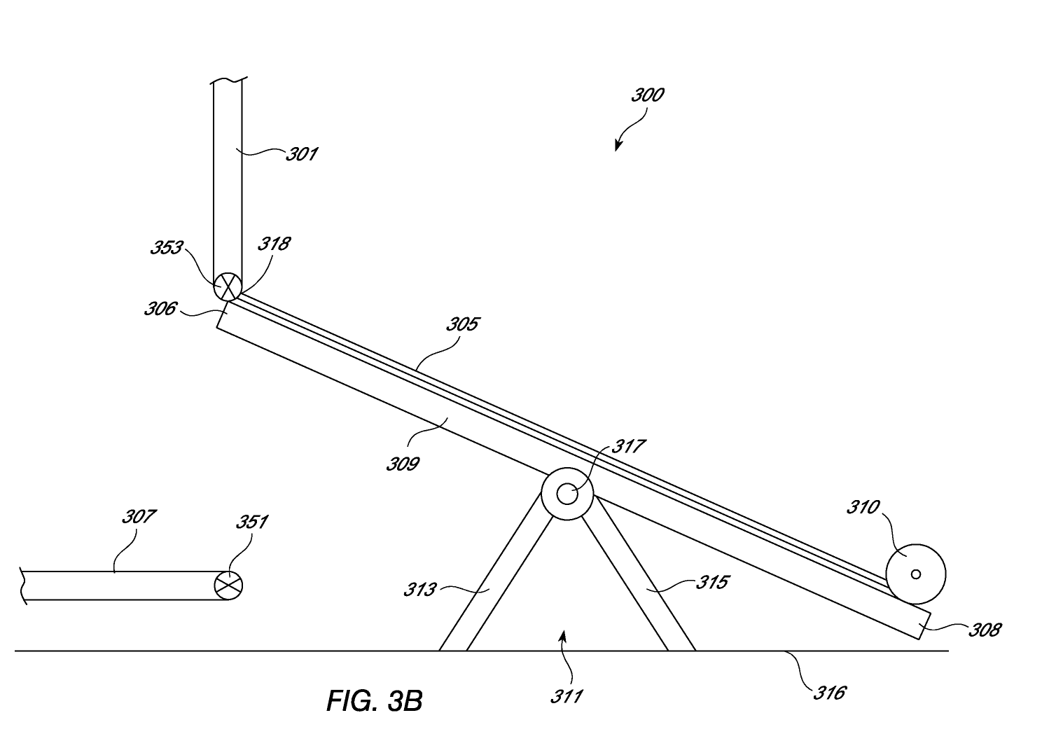

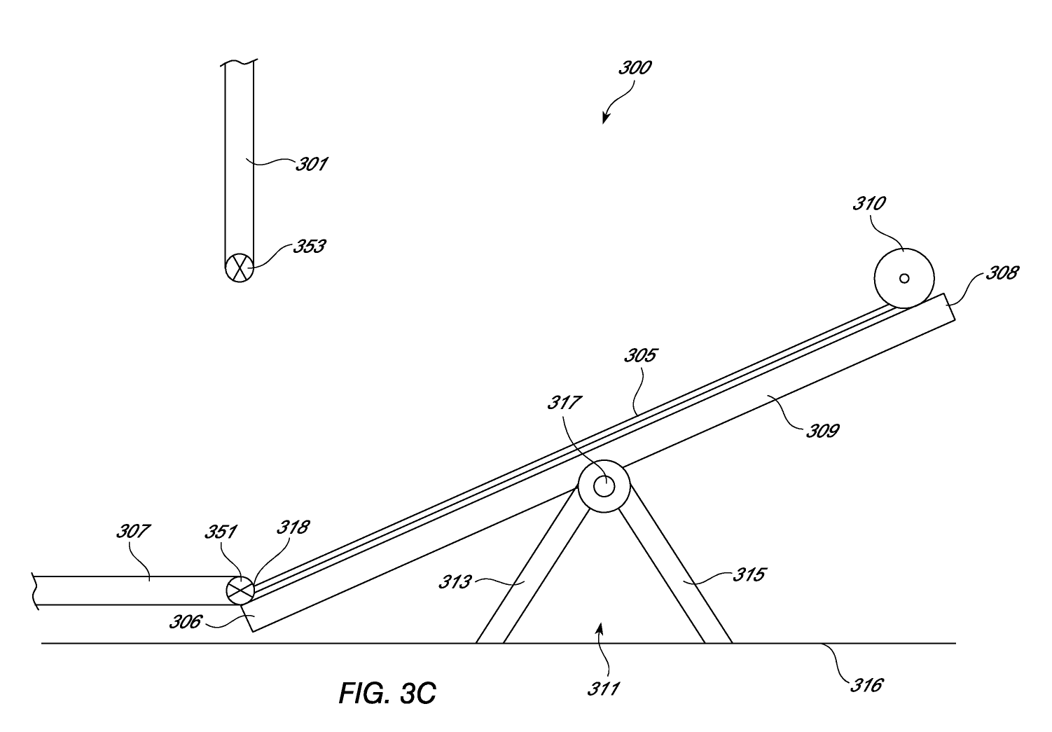

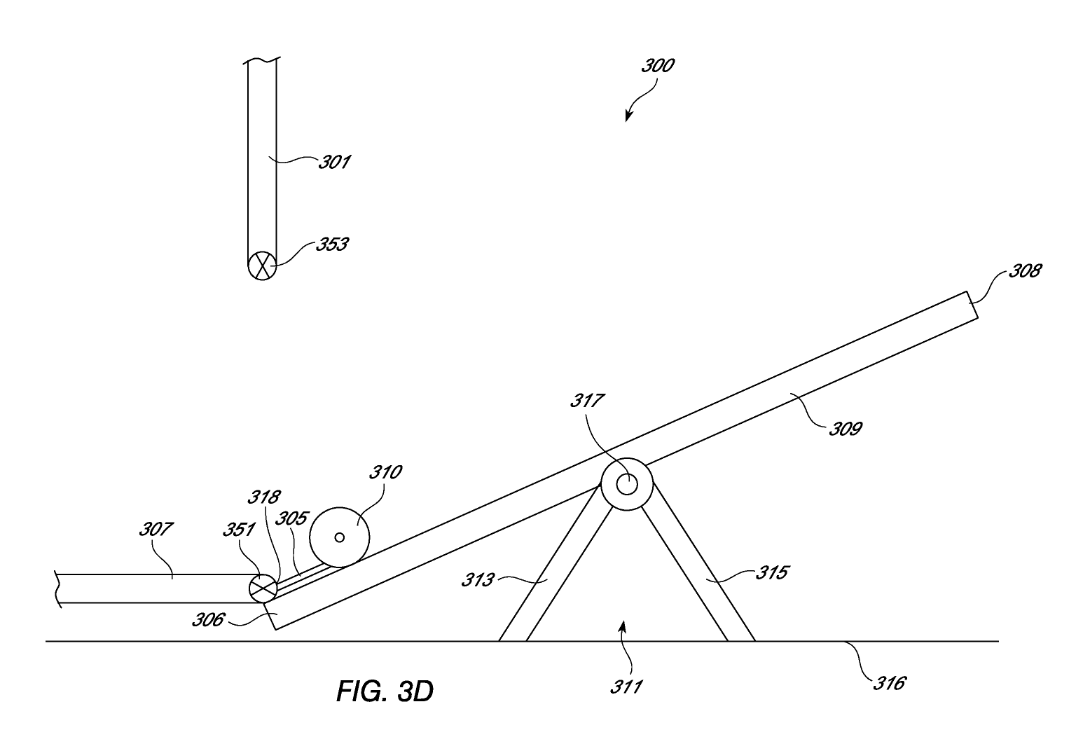

FIG. 2 schematically illustrates an embodiment of an energy conversion system 200 that may be incorporated in a fluid circulation system, for example, fluid circulation system 100 schematically illustrated in FIG. 1. The energy conversion system 200 can include an input lumen 213 that a pressurized working fluid may pass through. In some embodiments, the input lumen 213 may be a pipe. In some embodiments, the input lumen 213 is fluidly coupled to a source of pressurized working fluid, for example, an elevated pressure fluid storage reservoir or pressure input system (e.g., system 300 of FIGS. 3A-3D) such that working fluid passes through the input lumen 213 and exits an exit aperture or nozzle 214. In some embodiments, the input lumen 213 is fluidly coupled to a source of pressurized working fluid that is unused or wasted by another system or device (e.g., exhausted from an industrial building or power plant). The exit aperture or nozzle 214 can be configured to direct working fluid that passes therethrough over a plurality of energy conversion elements 201a, 201b. Each energy conversion element 201a, 201b can include a water wheel or pelton wheel 203a, 203b with paddles configured to engage the working fluid that passes through the exit aperture 214. In this way, the flow of the working fluid over the water wheels 203a, 203b causes the wheels 203a, 203b to rotate about an axis of rotation. The wheels 203a, 203b can be coupled to axles 204a, 204b such that rotation of the wheels 203a, 203b causes the axles to rotate. The axles 204a, 204b can be coupled to one or more electrical generators 205a, 205b, 207a, 207b such that the electrical generators convert the rotational motion of the axles to electrical energy. In this way, the energy conversion system 200 can convert energy stored within a pressurized working fluid to electrical energy that can be used or stored by an additional element.

In some embodiments, the energy conversion elements 201a, 201b can be disposed over a trough or reservoir 211 configured to receive and hold the working fluid. In some embodiments, the reservoir 211 can be open or covered to form a closed-loop circulation system. In this configuration, working fluid that passes through the energy conversion elements 201a, 201b can be received and stored by the reservoir 211 and recycled through the fluid circulation system. In some embodiments, the reservoir 211 can be positioned above one or more additional components (not shown) of the fluid circulation system such that working fluid received and stored by the reservoir 211 may be driven by gravity from the reservoir to the one or more additional components. In one embodiment, the reservoir 211 is fluidly coupled to an outlet lumen 215 that is also fluidly coupled with an additional component of the fluid circulation system, for example, a pressure input system (e.g., system 300 of FIGS. 3A-3D), such that the working fluid may pass therethrough from the reservoir to the additional component.

Turning now to FIG. 3A, a side elevational view of an embodiment of a pressure input system 300 is schematically illustrated. The pressure input system 300 can be incorporated in a fluid circulation system, for example, fluid circulation system 100 schematically illustrated in FIG. 1. In some embodiments, the pressure input system 300 includes a gravity driven pump system having an input lumen 301 that is fluidly coupled to a source of working fluid, for example, reservoir 211 of FIG. 2, and to a first lumen latch mechanism 353. The first lumen latch mechanism 353 can be configured to create a fluid pathway between the input lumen 301 and a roll-up bladder 305 by releasably latching an aperture 318 of the roll-up bladder to the first lumen latch mechanism 353. In some embodiments, when the roll-up bladder 305 is latched to the first lumen latch mechanism 353, working fluid may pass from the input lumen 301 through the first lumen latch mechanism into the roll-up bladder. In some embodiments, the first lumen latch mechanism 353 can include a one-way valve such that the working fluid may flow from the input lumen 301 to the roll-up bladder 305 but not in the opposite direction. The one-way valve can be configured such that working fluid may not pass through the first lumen latch mechanism 353 when a latch connection is not formed between the first lumen latch mechanism and the roll-up bladder 305. In some embodiments, the one-way valve may be controlled remotely or manually by an operator, for example, by a computer and/or a person.

With continued reference to FIG. 3A, the roll-up bladder 305 can be disposed on a rotatable bladder support 309 that can be configured to rotate about an axis of rotation 317 between at least a first configuration (shown) and a second configuration (FIGS. 3C and 3D). The axis of rotation 317 may be elevated from the ground or a base surface 316 by a support stand 311 that includes a first support member 313 and a second support member 315. Depending on the distance between the axis of rotation 317 and the base surface 316, the rotation of the bladder support 309 may be limited by the base surface 316. In one embodiment, the axis of rotation 317 is disposed halfway between a first end 306 and a second end 308 of the bladder support 309 and the distance between the axis of rotation and the base surface 316 is less than half of the length between the first end and the second end. In this embodiment, the rotation of the bladder support 309 about axis of rotation 317 may cause a portion of the bladder support 309 to abut a portion of the base surface 316 thereby limiting the range of motion of the bladder support about the axis. In other embodiments, the support stand 311 and/or bladder support 309 may be dimensioned such that the range of motion of the bladder support is not inhibited by the base surface 316. When the bladder support 309 is positioned in the first configuration, the first end 306 of the bladder support can be positioned higher than the second end 308 such that working fluid that passes through the first lumen latch mechanism 353 into the roll-up bladder 305 flows from the first end 306 toward the second end 308 by gravity. In some embodiments, the bladder support 309 can be secured relative to the base surface 316 in the first and/or second configurations by one or more securement devices, for example, releasable latches. In one embodiment, the bladder support 309 is secured relative to the base surface 316 in the first configuration by a releasable latch connection formed between the first lumen latch mechanism 353 and the roll-up bladder 305.

In some embodiments, pressure input system 300 can further include a bladder expelling element 310. As discussed in further detail below, in some embodiments, the expelling element 310 can be configured to travel or roll over the bladder support 309 between the first end 306 and the second end 308. The travelling of the expelling element 310 relative to the bladder support 309 can be controlled by one or more latches and/or similar releasable securement structures such that the expelling element 310 can be releasably secured in a first position (shown) near the first end 306 of the bladder support without travelling and/or in a second position (FIGS. 3B and 3C) near the second end 308 of the bladder support without travelling (e.g., rolling on the bladder support). Additionally, the expelling element 310 can be coupled to a distal end of the roll-up bladder 305 and the roll-up bladder may be configured to spool or wind around the expelling element 310 as the expelling element travels between the first and second positions. In other embodiments, the system 300 may include a bladder that does not spool or wind around an expelling element 310 but rather lies on the bladder support in a static configuration with an expelling element 310 configured to travel thereover.

As shown in FIG. 3B, when the expelling element 310 is released from the first position and the expelling element is biased toward the second position (shown) of the bladder support 309 by gravity, the roll-up bladder 305 can un-wind over the bladder support. In this way, when the expelling element 310 is in the second position, working fluid that passes through the first lumen latch mechanism 353 can flow into the roll-up bladder 305 such that the roll-up bladder 305 is substantially inflated with working fluid from the first end 306 of the bladder support 309 to near the second end 308.

Turning now to FIG. 3C, the bladder support 309 is schematically illustrated in the second configuration with the expelling element 308 secured relative to the bladder support in its second position. In the second configuration, the second end 308 of the bladder support 309 is raised higher than the first end 306 such that fluid contained within the roll-up bladder 305 is biased toward the first end by gravity. In this configuration, the aperture 318 of the roll-up bladder 305 can be releasably secured or latched to a second lumen latch mechanism 351 that is fluidly coupled to an outlet lumen 307. The second lumen latch mechanism 351 can be configured to create a fluid pathway between the roll-up bladder 305 by releasably latching the roll-up bladder to the outlet lumen 307. In this way, when the roll-up bladder 305 is latched to the second lumen latch mechanism 351, working fluid may pass from the roll-up bladder through the second lumen latch mechanism into the outlet lumen 307. In some embodiments, the second lumen latch mechanism 351 can include a one-way valve such that the working fluid may flow from the roll-up bladder 305 to the outlet lumen 307 but not in the opposite direction. The one-way valve can be configured such that working fluid may not pass through the second lumen latch mechanism 351 when a latch connection is not formed between roll-up bladder 305 and the outlet lumen 307. In some embodiments, the one-way valve may be controlled remotely or manually by an operator, for example, by a computer and/or a person. In some embodiments, the bladder support 309 is secured relative to the base surface 316 in the second configuration by a releasable latch connection formed between the second lumen latch mechanism 351 and the roll-up bladder 305.

As shown in FIG. 3D, when the bladder support 309 is in the second configuration, the expelling element 310 can be released from the second position near the second end 308 of the bladder support such that the expelling element is biased by gravity to travel or roll along the bladder support toward the first position (shown). In some embodiments, the expelling element 310 can be configured such that it expels working fluid from the roll-up bladder 305 into the outlet lumen 307 as the expelling element travels from the second position to the first position. As discussed in further detail below, in one embodiment, the expelling element 310 can include a member with a mass characteristic configured to produce a gravitational force on the expelling element sufficient to cause the expelling element to travel from the second position to the first position and spool the roll-up bladder 305 thereby expelling the working fluid from the roll-up bladder. In some embodiments, the pressurized working fluid can pass through the outlet lumen 307 to one or more pressurized fluid storage reservoirs and the pressurized working fluid can be distributed therefrom to additional components or systems, for example, to an energy conversion system (e.g., system 200 of FIG. 2) and/or to a pressure input re-set system (e.g., system 500 of FIG. 5). In other embodiments, the pressurized working fluid can pass through the outlet lumen 307 directly to one or more additional components or systems, for example, to an energy conversion system (e.g., system 200 of FIG. 2) and/or to a pressure input re-set system (e.g., system 500 of FIG. 5).

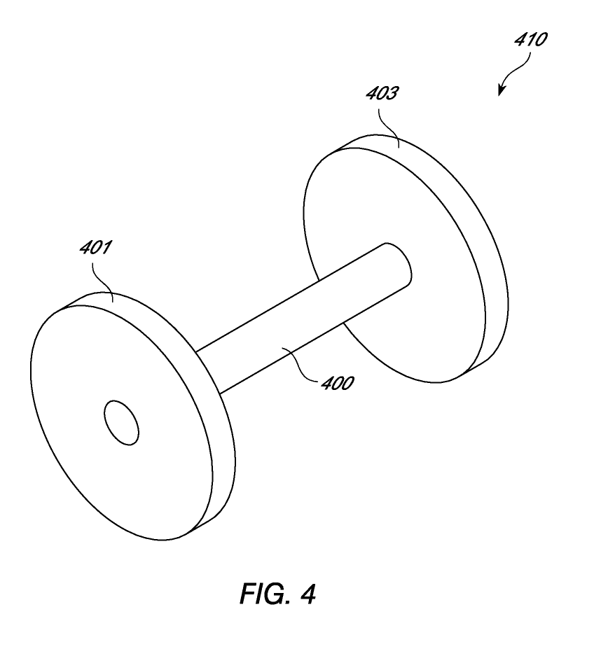

FIG. 4 schematically illustrates an embodiment of an expelling element 410 that may be configured to travel along a bladder support to expel fluid from a roll-up bladder pump system as discussed with reference to FIGS. 3A-3D. In some embodiments, the expelling element 410 can include a first wheel 401, a second wheel 403, and an axle 400 extending therebetween. The first and second wheels 401, 403 can be similarly shaped and sized such that they roll evenly together on a given rolling surface. Additionally, the axle 400 may be secured relative to the first and second wheels 401, 403 such that the axle rotates at the same angular velocity that the first and second wheels rotate at when the expelling element 410 is travelling or rolling along a given surface. In some embodiments, the first and second wheels 401, 403 are sufficiently spaced apart such that they form a receiving space therebetween for spooling and un-spooling (e.g., winding and un-winding) a roll-up bladder (not shown). In some embodiments, an expelling element can be differently shaped, for example, an expelling element can comprise a cylindrical roller.

In one embodiment, a roll-up bladder may be coupled to the axle 400 such that the expelling element 410 un-spools the roll-up bladder when the expelling element 410 rolls in a first direction and such that the expelling element spools the roll-up bladder when the expelling element rolls in a second direction that is opposite to the first direction. Additionally, the expelling element 410 can be configured to have a mass characteristic that results in a large gravitational force on the expelling element 410. In some embodiments, the axle 400 can include a high density material to increase the mass characteristic of the expelling element 410. In one embodiment, the first and second wheels 401, 403 can also include a high density material to increase the mass characteristic of the expelling element. In some embodiments, additional components, for example, high mass bars, can be added to the expelling element 410 to increase the mass characteristic thereof.

One having ordinary skill in the art will understand how the pressure input system 300 of FIGS. 3A-3D can pressurize a working fluid provided into the system by moving the bladder support 309 between the first and second configurations and also by allowing the expelling element 310 to travel between the first and second positions. As discussed herein below, various systems can be used to “re-set” the pressure input system 300. As used herein “re-setting the pressure input system 300” can refer to moving the bladder support system from the first configuration to the second configuration and/or from the second configuration to the first configuration.

FIG. 5 schematically illustrates an embodiment of a pump re-set system 500 that includes a hydro-prop 502. The hydro-prop 502 includes a first blade 503a and a second blade 503b that are configured to rotate about an axle 517. The axle 517 can be supported by axle supports 511 such that the axle is positioned sufficiently above a base surface to allow the blades 503a, 503b to rotate continuously about the axle in a first and/or second direction.

The pump re-set system 500 can include an inlet lumen 521 that receives pressurized working fluid therethrough. In one embodiment, the inlet lumen 521 can receive pressurized working fluid from a pressure input system (e.g., system 300 of FIGS. 3A-3D), from an elevated pressure fluid storage reservoir (e.g., storage reservoir 105 of FIG. 1), and/or from a source of unused energy or waste energy. The inlet lumen 521 can be fluidly coupled to blade lumens 501a, 501b such that pressurized working fluid passes from the inlet lumen through the blade lumens 501a, 501b and is expelled through exit apertures 505a, 505b. The diameters of the inlet lumen 521 and blade lumens 501a, 501b can be dimensioned such that the velocity of the working fluid increases as the pressurized fluid flows from the inlet lumen 521 into the blade lumens 501a, 501b. In some embodiments, the system 500 can include an optional accelerator or throttle (not shown) disposed at least partially between the inlet lumen 521 and the blade lumens 501a, 501b. In one embodiment, the diameter of the inlet lumen 521 can be about ½ of an inch and the diameters of the blade lumens 501a, 501b can each be about ⅛ of an inch resulting in an increase of flow velocity through the blade lumens from the flow through the inlet lumen 521. As the working fluid is expelled from the exit apertures 505a, 505b, the blades 503a, 503b are propelled about the axle 517 in a direction opposite to the direction that the working fluid is expelled.

In some embodiments, the exit apertures 505a, 505b can be oriented to face in opposite rotational directions (e.g., clockwise and counter-clockwise) such that expulsion of the working fluid through a first exit aperture 505a propels the blade 503a in a first direction and expulsion of the working fluid through a second fluid aperture 505b propels the blade 503b in a second direction opposite to the first direction. In some embodiments, the system 500 optionally includes a valve or diverter 519 configured to divert the flow of working fluid from the inlet lumen 521 to one of the two blade lumens 501a, 501b to selectively propel the hydro-prop 502 in one of two opposite directions. In one embodiment, a fluid pathway can be established by the diverter 519 between the inlet lumen 521 and one of the two blade lumens 501a, 501b while a fluid pathway is not established between the inlet lumen and the other of the two blade lumens to propel the hydro-prop 502 in a first direction and the diverter can be actuated to change the fluid pathway through the diverter to propel the hydro-prop in the opposite direction about the axle 517. In some embodiments, the exit apertures 505a, 505b can be oriented to face in the same rotational direction (e.g., clockwise or counter-clockwise) such that expulsion of the working fluid through each of the apertures 505a, 505b propels the blades 503a, 503b in the same direction. In some embodiments, each blade lumen 501a, 501b can include two exit apertures (not shown) facing in opposite rotational directions. In some embodiments, a diverter (not shown) can be disposed between two opposite facing exit apertures on the first blade lumen and a diverter (not shown) can be disposed between two opposite facing exit apertures on the second blade lumen. In this way, the diverters can establish up to four different fluid pathways to propel the hydro-prop in one of two opposite directions. By causing the hydro-prop 502 to rotate about the axle 517, the pump re-set system 500 can be used to convert energy stored in pressurized fluid to rotational motion.

In some embodiments, the hydro-prop 502 can be coupled to a flexible tension member (not shown) that is coupled to a winch system (not shown). The winch system can be used to re-set a pressure input system, for example, the pressure input system of FIGS. 3A-3D. In one embodiment, the hydro-prop 502 can be propelled in a first direction to re-set the pressure input system between the first configuration and a second configuration and the hydro-pump 502 can be propelled in the second direction to re-set the pressure input system between the second configuration and the first configuration. In one embodiment, the flexible tension member is routed through a pulley system including one or more pulleys configured to provide a mechanical advantage for driving the winch system. In some embodiments, the flexible tension member can be coupled to a transmission system that is coupled to a winch system to facilitate re-setting a pressure input system.

One having ordinary skill in the art will appreciate that in some embodiments, pressure re-set systems can have more than one hydro-prop. For example, a pressure re-set system can have a first hydro-prop that can be propelled by a pressurized fluid to rotate in a clockwise direction and a second hydro-prop that can be propelled by a pressurized fluid to rotate in a counter-clockwise direction. In one embodiment, a pressure input re-set system with at least two hydro-props can be operatively coupled to at least two winch systems with a first winch system configured to re-set a pressure input system in a first direction and a second winch system configured to re-set a pressure input system in a second direction that is opposite to the first direction. For example, pressure input system 300 from FIGS. 3A-3D can be re-set from the first configuration to the second configuration by a first winch system that is operatively coupled to a first hydro-prop in a pressure input re-set system and/or can be re-set from the second configuration to the first configuration by a second winch system that is operatively coupled to a second hydro-prop in the pressure input re-set system.

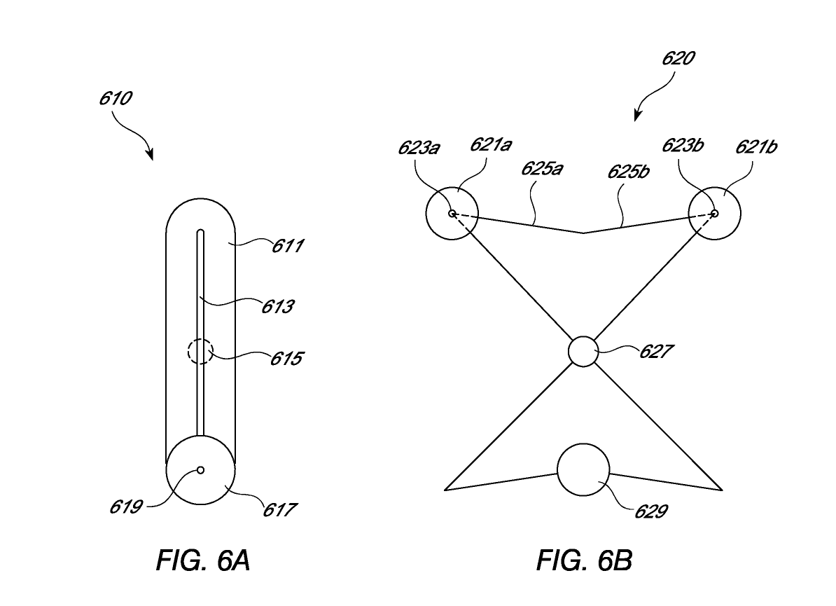

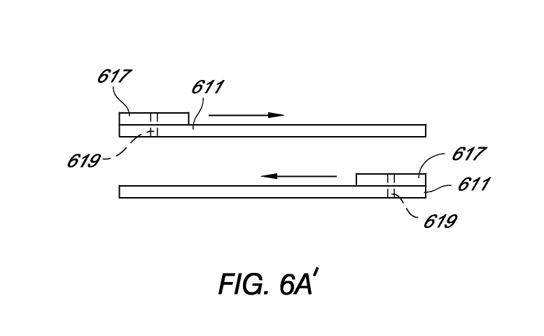

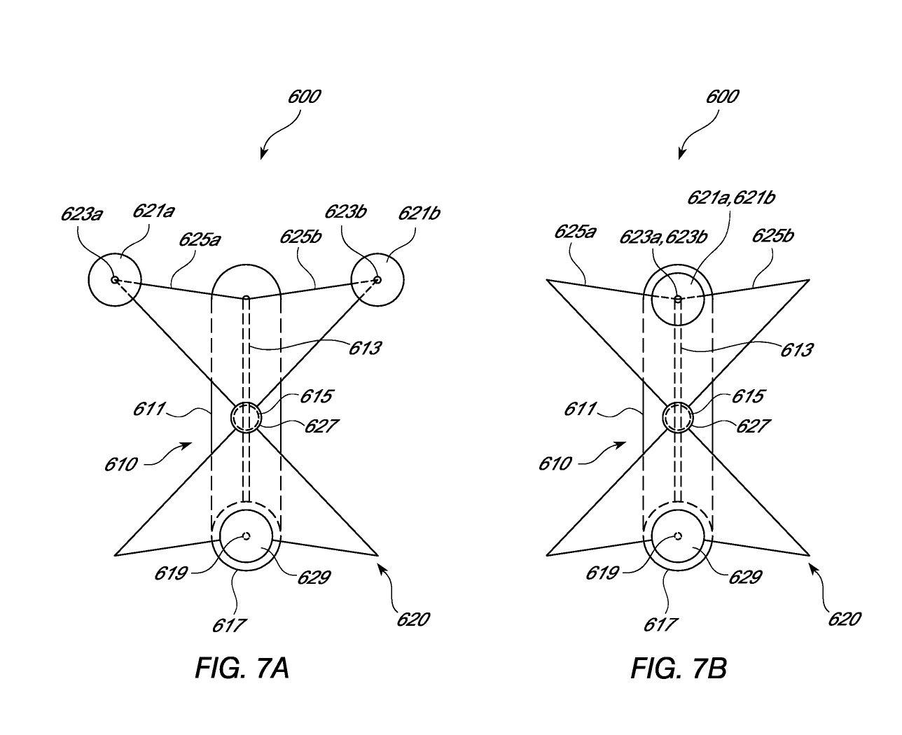

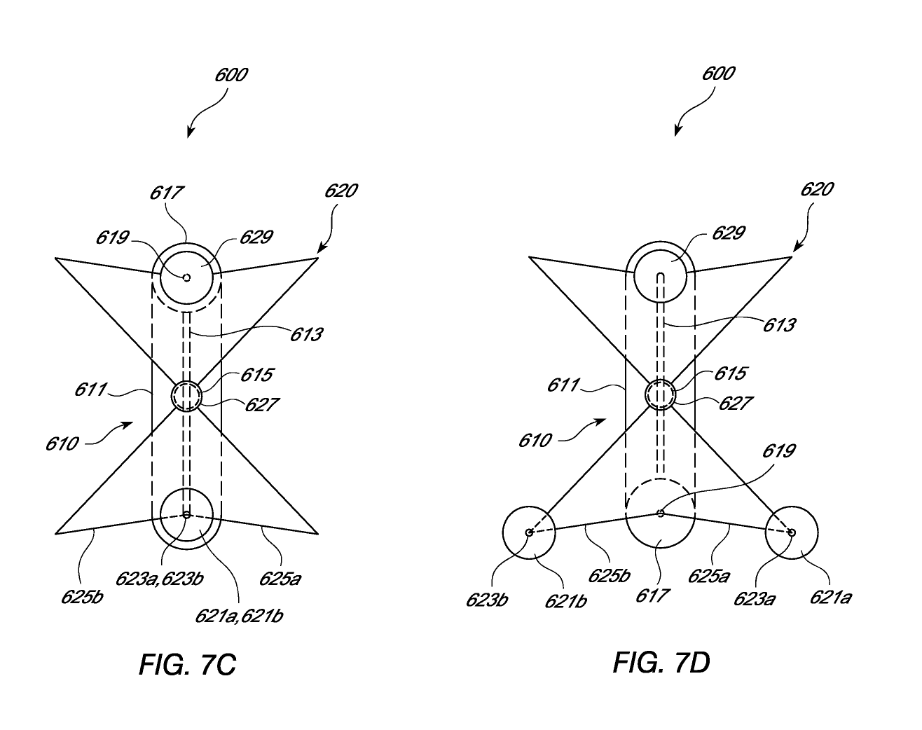

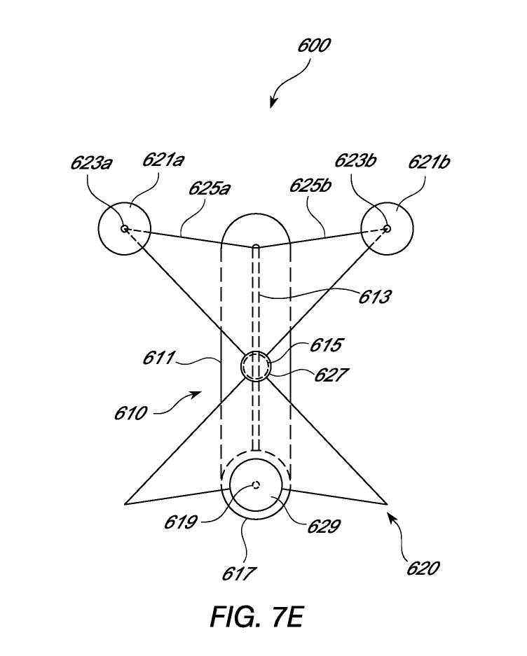

FIGS. 6A, 6A′, and 6B schematically illustrate components that can be incorporated in another embodiment of pressure input re-set system 600 (schematically illustrated in FIGS. 7 and 8). FIG. 6A illustrates a side elevational view of an embodiment of a rotatable arm 610 that includes a body member 611, a track 613 disposed within the body member 611, and a pin 619 configured to slide within the track 613 between two opposite ends of the body member 611. As shown in FIG. 6A′, the rotatable arm 610 can also include a slidable weight 617 that is coupled to the pin 619 and configured to slide between two opposite ends of the arm member 611 parallel to the arm member when the pin 619 is moved within the track 613. As discussed in further detail below, the arm member 611, weight 617, and pin 619 can all be configured to rotate about a fixed axle or rod 615 disposed in the center of the body member 611.

FIG. 6B schematically illustrates a side elevational view of an embodiment of a rotatable frame 620 including a fixed weight 629 and at least two movable weights 621a, 621b disposed on an opposite side of the frame 620 from the fixed weight 629. The movable weights 621a, 621b, the fixed weight 629, and the slidable weight 617 of the rotatable arm 610 can each be configured such that each element is equal in mass to each other element. That is to say, the movable weights 621a, 621b can each have the same mass, and this mass can be equal to the mass of the fixed weight 629 and to the mass of the slidable weight 617. The movable weights 621a, 621b can be coupled to pins 623a, 623b that are configured to slide along inclined rails 625a, 625b of the frame 620 between a midline of the frame 620 and away from the midline. The frame 620, including the movable weights 621a, 621b and fixed weight 629, can be configured to rotate about a fixed axle or rod 627 disposed near the center of the rotatable frame 620.

FIGS. 7A-7E schematically illustrate an embodiment of a pressure input re-set system 600 that includes the rotatable arm 610 of FIGS. 6A and 6A′ and the rotatable frame 620 of FIG. 6B. Some portions of the pressure input re-set system 600 in FIGS. 7A-7E are depicted with dashed lines to denote that these portions are positioned underneath another illustrated layer or structure. For example, in FIGS. 7A-7E the rotatable frame 620 is generally disposed between the rotatable arm 610 and the viewer. Thus, portions of the rotatable arm 610, e.g., portions of the slidable weight 617, may be depicted in FIGS. 7A-7E with dashed lines to indicate that these portions are behind intervening portions of the rotatable frame 620. As discussed in more detail below with reference to FIGS. 8A and 8B, the pressure input re-set system 600 can be used to re-set the pressure input system 300 of FIGS. 3A-3D.

As shown in FIG. 7A, the rotatable arm 610 can be aligned with the rotatable frame 620 such that the axle 615 of the rotatable arm is coaxial with the axle 627 of the rotatable frame. In this way, the components of the rotatable arm 610 and the components of the rotatable frame 620 can all be configured to rotate about a common axis. FIG. 7A illustrates the pressure input re-set system 600 in a first position wherein the slidable weight 617 of the rotatable arm 610 and the fixed weight 629 of the rotatable frame 620 are aligned at the bottom of the system 600 along the midline of the frame. Additionally, in the first position, the movable weights 621a, 621b can be disposed at the top of the system 600 and can be juxtaposed on opposite sides of the body member 611 along their respective rails 625a, 625b. The movable weights 621a, 621b can be positioned such that each movable weight 621a, 621b is equally spaced from the other movable weight and the fixed weight 629. With this spatial distribution of the movable weights 621a, 621b and the fixed weight 629, the movable frame 620 can be balanced about the axle 627 such that the frame is not biased by gravity to rotate about the axle 627. To maintain this balance and positioning, the movable weights 621a, 621b can be releasably secured relative to their respective rails 625a, 625b by a latch or other securement device such that they are inhibited from sliding along the rails. In some embodiments, the latches or securement devices configured to fix the movable weights 621a, 621b relative to the rails 625a, 625b can be controlled remotely or manually by an operator, for example, by a computer and/or a person.

Turning now to FIG. 7B, the movable weights 621a, 621b can be released from their fixed positions in the first position such that each of the movable weights 621a, 621b is biased to slide along its respective inclined rail 625a, 625b toward the midline of the pressure input re-set system 600. When released, the movable weights 621a, 621b can be biased by gravity to move from their position shown in FIG. 7A to the position shown in FIG. 7B. Upon reaching the position shown in FIG. 7B, the movable weights 621a, 621b can again be releasably secured relative to their respective rails 625a, 625b such that the movable weights 621a, 621b are inhibited from moving relative to the rails.

In this second position of the pressure input re-set system 600 illustrated in FIG. 7B, the movable weights 621a, 621b can be aligned with one another and disposed opposite to the fixed weight 629 and slidable weight 617 on the opposite side of the system 600. The release of the movable weights 621a, 621b from the positions illustrated in FIG. 7A can trigger the releasable attachment of the slidable weight 617 to the fixed weight 629 such that rotation of one of the slidable weight 617 and the fixed weight 629 about the common axis causes the rotation of the other. In this way, once the movable weights 621a, 621b reach the position shown in FIG. 7B, the pressure input re-set system 600 can remain balanced about the common axis of rotation because the combined masses of the movable weights 621a, 621b will equal the combined masses of the fixed weight 629 and slidable weight 617.

Turning now to FIG. 7C, the pressure input re-set system 600 can be turned 180 degrees (e.g., a one-half turn) from the second position illustrated in FIG. 7B to the third position illustrated in FIG. 7C. The pressure input re-set system 600 can be turned using various systems and/or methods. For example, the pressure input re-set system 600 can be turned by a winch and/or a hydro-prop (e.g., hydro prop 502 of FIG. 5). In some embodiments, a hydro-prop or winch used to turn the pressure input re-set system 600 can be powered, at least in part, by a working fluid pressurized by a pressure input system (e.g., system 300 of FIGS. 3A-3D). In some embodiments, the pressure input re-set system 600 can be driven, at least in part, by energy received from a source of waste energy or unused energy as discussed above with respect to other components and embodiments. While in the third position, the pressure input re-set system 600 can be balanced about the common axis of rotation with the slidable weight 617 and the fixed weight 629 disposed directly above the movable weights 621a, 621b.

Turning now to FIG. 7D, the pressure input re-set system 600 is illustrated in a fourth position. To change from the third position (FIG. 7C) to the fourth position, the movable weights 621a, 621b can be released relative to the inclined rails 625a, 625b such that the movable weights 621a, 621b slide along their respective rails away from one another. Further, the slidable weight 617 can be released from the fixed weight 629 such that the slidable weight 617 and corresponding pin 619 are biased by gravity along the track 613 away from the fixed weight and downward toward the bottom of the system 600. This falling or dropping of the slidable weight 617 when transitioning from the third position to the fourth position may be utilized to re-set the pressure input system 300 of FIGS. 3A-3D as discussed below.

As shown in FIG. 7E, the pressure input re-set system 600 can be turned 180 degrees from the fourth position shown in FIG. 7D to the first position (FIG. 7E). Upon returning to the first position, the slidable weight 617 may once again be secured relative to the fixed weight 629 such that rotation or movement of the fixed weight causes rotation or movement of the slidable weight 617 and such that the slidable weight 617 is inhibited from moving freely along the track 613. As shown by FIGS. 7E-7A, the pressure input re-set system 600 can cycle sequentially through at least the four positions described herein to repeatedly provide a re-set mechanism for a pressure input system as needed.

Turning now to FIGS. 8A and 8B, the pressure input re-set system 600 of FIGS. 7A-7E is shown in relation to the pressure input system 300 of FIGS. 3A-3D. As illustrated in FIG. 8A, the bladder support 309 is in the second configuration and the expelling element 310 has expelled the working fluid from the roll-up bladder 305 into the outlet lumen 307. From this configuration, the bladder support can be re-set to the first configuration such that the expelling element 310 is biased toward the opposite end of the bladder support 309 and such that the roll-up bladder 305 may be un-spooled and re-filled with working fluid through the input lumen 301. To re-set the bladder support 309, the pressure input re-set system 600 may be disposed over the second end 308 of the bladder support such that the slidable weight 617 applies a force to the second end of the bladder support when the pressure input re-set system 600 transitions from the third position to the fourth position as discussed above with reference to FIGS. 7C and 7D. As shown in FIG. 8B, the force applied by the slidable weight 617 on the bladder support 309 can act to re-set the bladder support such that the expelling element 310 is biased toward the second end 308 which can allow the bladder 305 to be re-filled with working fluid. In this way, the pressure input re-set system 600 can work in concert with the pressure input system 300 to pressurize working fluid received through the input lumen 310 and expel the pressurized working fluid through the outlet lumen 307 over one or more cycles.

Some embodiments of a fluid circulation system can incorporate one or more of the systems disclosed herein, for example the systems in FIGS. 2-8, to form an open or closed-loop system. In one embodiment, outlet lumen 215 of energy conversion system 200 can be fluidly coupled to input lumen 301 of pressure input system 300 and output lumen 307 of the pressure input system 300 can be fluidly coupled to inlet lumen 521 of pump re-set system 500. In some embodiments, outlet lumen 307 of the pressure input system 300 can be fluidly coupled to inlet lumen 213 of energy conversion system 200 and can also be fluidly coupled to inlet lumen 521 of pump re-set system 500. In one such embodiment, an elevated pressure fluid storage reservoir is disposed between the pressure input system 300 and the energy conversion system 200 and/or between the pressure input system 300 and the pump re-set system 500. In one embodiment, outlet lumen 215 of energy conversion system 200 can be fluidly coupled to input lumen 301 of pressure input system 300, output lumen 307 of the pressure input system 300 can be fluidly coupled to inlet lumen 521 of pump re-set system 500 and to inlet lumen 213 of energy conversion system 200, and the pressure input re-set system 500 can be coupled to the pressure input system 300. In one embodiment, outlet lumen 215 of energy conversion system 200 can be fluidly coupled to input lumen 301 of pressure input system 300, output lumen 307 of the pressure input system 300 can be coupled to an elevated pressure fluid storage reservoir, and the elevated pressure fluid storage reservoir can be fluidly coupled to inlet lumen 213 of energy conversion system 200.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A pressure input system comprising:
a bladder support configured to rotate about an axis of rotation between at least a first configuration and a second configuration, the bladder support comprising a first end and a second end opposite the first end, wherein a distance between the first end and a ground surface when the bladder support is in the first configuration is greater than a distance between the second end and the ground surface, and wherein a distance between the first end and the ground surface when the bladder support is in the second configuration is less than a distance between the second end and the ground surface;
an expelling element configured to travel on a surface of the bladder support between a first position and a second position, wherein the first position is nearer to the first end than the second end and wherein the second position is nearer to the second end than the first end; and
a bladder disposed over the bladder support and coupled to the expelling element, wherein the bladder is configured to spool around the expelling element when the expelling element travels from the second position to the first position, wherein the bladder is configured to un-spool from the expelling element when the expelling element travels from the first position to the second position, and wherein the bladder comprises an aperture configured to receive and expel a working fluid therethrough.

2. The pressure input system of claim 1, wherein the expelling element is configured to expel working fluid from the bladder as the expelling element travels from the second position to the first position.

3. The pressure input system of claim 1, further comprising a first releasable latch configured to releasably secure the expelling element relative to the bladder support when the expelling element is in the first position.

4. The pressure input system of claim 1, further comprising a second releasable latch configured to releasably secure the expelling element relative to the bladder support when the expelling element is in the second position.

5. The pressure input system of claim 1, further comprising an input lumen positioned to fluidly communicate with the bladder aperture when the bladder support is in the first position.

6. The pressure input system of claim 5, further comprising a first lumen latch mechanism coupled to the input lumen, wherein the first lumen latch mechanism is configured to engage the bladder aperture when the bladder support is in the first position.

7. The pressure input system of claim 6, wherein the first lumen latch mechanism is configured to releasably secure the bladder to the input lumen when the bladder support is in the first position.

8. The pressure input system of claim 6, wherein the first lumen latch mechanism comprises a one-way valve that is configured to allow the working fluid to pass therethrough from the input lumen into the bladder.

9. The pressure input system of claim 1, further comprising an output lumen positioned to fluidly communicate with the bladder aperture when the bladder support is in the second position.

10. The pressure input system of claim 9, further comprising a second lumen latch mechanism coupled to the output lumen, wherein the second lumen latch mechanism is configured to engage the bladder aperture when the bladder support is in the second position.

11. The pressure input system of claim 10, wherein the second lumen latch mechanism is configured to releasably secure the bladder to the output lumen when the bladder support is in the second position.

12. The pressure input system of claim 10, wherein the second lumen latch comprises a one-way valve that is configured to allow the working fluid to pass therethrough from the bladder into the output lumen.

13. A system comprising:
a pressure input system comprising:
a bladder support configured to rotate about an axis of rotation between at least a first configuration and a second configuration, the bladder support comprising a first end and a second end opposite the first end, wherein a distance between the first end and a ground surface when the bladder support is in the first configuration is greater than a distance between the second end and the ground surface, and wherein a distance between the first end and the ground surface when the bladder support is in the second configuration is less than a distance between the second end and the ground surface,
an expelling element configured to travel on a surface of the bladder support between a first position and a second position, wherein the first position is nearer to the first end than the second end and wherein the second position is nearer to the second end than the first end, and
a bladder disposed over the bladder support and coupled to the expelling element, wherein the bladder is configured to spool around the expelling element when the expelling element travels from the second position to the first position, wherein the bladder is configured to un-spool from the expelling element when the expelling element travels from the first position to the second position, and wherein the bladder comprises an aperture configured to receive and expel a working fluid therethrough; and
a pressure input re-set system configured to apply a force to the bladder support when the bladder support is in the first configuration sufficient to rotate the bladder support about the axis of rotation to the second configuration.

14. The system of claim 13, wherein the pressure input re-set system comprises:
a rotatable arm having a body and a slidable weight configured to slide along a length of the body; and
a rotatable frame having a fixed weight and at least two movable weights, wherein the rotatable arm and the rotatable wheel are aligned such that they are configured to rotate about a common axis.

15. The system of claim 14, further comprising a latch configured to releasably secure slidable weight relative to the fixed weight.

16. The system of claim 15, wherein the rotatable frame comprises at least two rails, and wherein each movable weight is configured to move along one of the at least two rails.

17. A system for circulating fluid, the system comprising:
a fluid storage reservoir disposed above a ground surface and configured to store at least a portion of a working fluid;
a pressure input system disposed between the fluid storage reservoir and the ground surface, the pressure input system configured to receive the working fluid from the fluid storage reservoir, the pressure input system configured to pressurize the working fluid; and
an energy conversion system, the energy conversion system configured to receive pressurized working fluid from the pressure input system and direct the pressurized working fluid over at least one energy conversion element.

18. The system of claim 17, wherein the at least one energy conversion element comprises a water wheel.

19. The system of claim 18, further comprising an electrical generator operatively coupled to the water wheel.

20. The system of claim 18, wherein the water wheel comprises a wheel with at least one paddle configured to engage the pressurized working fluid.

21. The system of claim 17, wherein the at least one energy conversion element comprises a pelton wheel.

22. The system of claim 21, further comprising an electrical generator operatively coupled to the pelton wheel.

23. The system of claim 17, wherein the pressure input system comprises a gravity driven pump system.

24. The system of claim 23, further comprising a pressure input re-set system.

25.-37. (canceled)
